(19) United States
(12) Patent Application Publication
(10) Pub. No.: US 2026/0211252 A1
(43) Pub. Date: Jul. 23, 2026

(54) TUNABLE BESSEL BEAM MODULE

(71) Applicants: The Trustees of Princeton University, Princeton, NJ (US); University of Maryland, Baltimore, BALTIMORE, MD (US)

(72) Inventors: Tian-Ming Fu, Princeton, NJ (US); Mengyang Li, Princeton, NJ (US); Yajie Liang, Ellicott City, MD (US)

(73) Assignees: The Trustees of Princeton University, Princeton, NJ (US); University of Maryland, Baltimore, BALTIMORE, MD (US)

(21) Appl. No.: 19/396,533

(22) Filed: Nov. 21, 2025

Related U.S. Application Data
(60) Provisional application No. 63/747,545, filed on Jan. 21, 2025.

(51) Int. Cl. G02B 27/09

(52) U.S. Cl. CPC G02B 27/0927; G02B 27/0955; G02B 27/0977

(57) ABSTRACT

A tunable Bessel beam module comprises a first axicon configured to receive light along an optical path, a first lens disposed along the optical path such that the first axicon and first lens generate a Bessel beam, an adjustable iris disposed at a focal plane of the first lens, and two separated axicons configured to receive the Bessel beam focus from the first lens, separated by an adjustable distance along the optical path. The module enables independent control of numerical aperture and beam confinement without introducing axial shifts. The adjustable iris controls beam confinement (ΔNA) while the separation distance between the two axicons controls the numerical aperture (NA). The module may include a 4f lens system, mirrors, motorized control, and housing for integration into microscopy, optical tweezers, medical imaging, laser machining, or optical communications applications.

### CROSS-REFERENCE TO RELATED APPLICATIONS

This application claims priority to U.S. Provisional Application No. 63/747,545, titled TUNABLE BESSEL BEAMS, filed Jan. 21, 2025, which is hereby incorporated by reference in its entirety.

### STATEMENT REGARDING FEDERALLY SPONSORED RESEARCH OR DEVELOPMENT

This invention was made with government support under Grant Nos. 1R21EB035681 and R21AG077631 awarded by the National Institutes of Health. The government has certain rights in the invention.

### TECHNICAL FIELD

The present disclosure relates to optical beam generation systems for microscopy applications, and more particularly to a tunable Bessel beam module that enables independent control of numerical aperture and beam confinement for high-speed volumetric imaging of biological samples.

### BACKGROUND

Optical microscopy has become an indispensable tool for studying biological systems, enabling researchers to visualize cellular structures and dynamic processes in living tissues. Two-photon fluorescence microscopy (TPFM) has emerged as a particularly powerful technique for deep tissue imaging due to its ability to achieve high spatial resolution while minimizing photodamage and background fluorescence. However, conventional TPFM systems face limitations when attempting to capture rapid three-dimensional biological processes, as they typically require sequential scanning through multiple focal planes to construct volumetric images.

The speed limitations of conventional volumetric imaging become particularly problematic when studying dynamic biological phenomena such as blood flow, neural activity, or cellular migration. These processes often occur on timescales that are faster than the acquisition rates achievable with traditional point-scanning approaches. As a result, researchers may miss transient events or be unable to capture the full temporal dynamics of the biological systems under investigation.

Bessel beams offer a potential solution to these speed limitations due to their unique propagation characteristics. Unlike conventional Gaussian beams that exhibit rapid divergence, Bessel beams maintain a relatively constant beam profile over extended propagation distances, creating what is known as a non-diffracting or propagation-invariant beam. This extended focal region allows for simultaneous illumination across multiple depths within a sample, potentially enabling volumetric imaging without the need for axial scanning.

Despite their advantages, the practical implementation of Bessel beam microscopy has been hindered by several technical challenges. Many existing approaches for generating tunable Bessel beams rely on complex and expensive programmable spatial light modulators (SLMs), which can be wavelength-specific, inefficient, and require sophisticated control systems. Additionally, conventional tuning methods often introduce unwanted axial shifts in the beam position when beam parameters are adjusted, complicating the imaging process and potentially causing loss of focus on the region of interest.

The field would benefit from more accessible and cost-effective approaches to Bessel beam generation that provide independent control over beam parameters while maintaining stability and ease of use. Such systems would enable broader adoption of high-speed volumetric imaging techniques across various research applications, from neuroscience and vascular biology to developmental studies and disease research.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

A tunable Bessel beam module may include a first axicon that may be configured to receive light along an optical path, a first lens that may be disposed along the optical path such that the first axicon and the first lens may generate a Bessel beam, an adjustable iris that may be disposed at a focal plane of the first lens, and two separated axicons that may be configured to receive the Bessel beam focus from the first lens, where the two separated axicons may be separated by a separation distance along the optical path, and where at least one of the two separated axicons may be moveable such that the separation distance may be adjusted. This configuration enables independent control of numerical aperture and beam confinement without introducing axial shifts in the imaging volume, providing enhanced flexibility for optimizing beam parameters across different imaging applications while maintaining high light efficiency through the use of standard optical components.

The tunable Bessel beam module may further include two separated lenses that may form a 4f system disposed in the optical path following the two separated axicons. This 4f relay system provides precise imaging of the ring focus onto scanning galvanometers, enabling seamless integration with existing microscopy systems while maintaining beam quality and minimizing aberrations.

The tunable Bessel beam module may further include one or more mirrors that may be disposed in the optical path. The mirrors enable compact beam routing and facilitate modular integration into existing optical systems, reducing the overall footprint while providing flexibility in system configuration.

At least one of the one or more mirrors may be disposed in the optical path between the adjustable iris and the first lens. This positioning allows for efficient beam steering while maintaining the critical spatial relationships between optical components for proper Bessel beam generation.

At least one of the one or more mirrors may be disposed in the optical path between the two separated axicons and the two separated lenses. This configuration enables compact folding of the optical path, reducing system size while preserving the optical performance of the beam generation module.

The tunable Bessel beam module may further include a housing that may surround the first axicon, the first lens, the adjustable iris, and the two separated axicons. The housing provides mechanical stability, protection from environmental disturbances, and facilitates easy integration as a modular component in various optical systems.

The tunable Bessel beam module may further include a motor that may be configured to control the separation distance of the two separated axicons. The motorized control enables automated adjustment of beam parameters, allowing for real-time optimization and programmable beam configurations without manual intervention.

The separation distance may be configured to lead to a Bessel beam whose length may be no more than 200 μm. This length range provides optimal balance between imaging depth coverage and structural overlap in biological samples, enabling effective volumetric imaging of cortical tissue layers while maintaining spatial resolution.

A system may include a tunable Bessel beam module and one or more lenses or mirrors that may be disposed in an optical path between the tunable Bessel beam module and a target. This system configuration enables versatile applications across multiple fields including microscopy, optical manipulation, and laser processing, with the tunable beam parameters providing adaptability to different sample types and imaging requirements.

The system may further include a light source that may be configured to generate the light forming the optical path. The integrated light source provides a complete imaging solution, enabling turnkey operation for high-speed volumetric imaging applications.

The system may further include a sensor that may be configured to receive light from the target. The sensor enables detection of fluorescence or scattered light from the sample, completing the imaging chain for quantitative measurements of biological processes such as blood flow dynamics.

At least one of the one or more lenses or mirrors may form a scanning galvanometer. The scanning capability enables rapid beam positioning for high-speed imaging, allowing volumetric coverage rates that are orders of magnitude faster than conventional point-scanning approaches.

At least one of the one or more lenses or mirrors may be an objective lens. The objective lens focuses the Bessel beam into the sample, providing the high numerical aperture needed for sub-cellular resolution while maintaining the extended focal region characteristic of Bessel beams.

The system may define a microscopy system, an optical tweezer system, a medical imaging system, a laser machining system, or an optical communications system. This versatility demonstrates the broad applicability of the tunable Bessel beam technology across diverse fields, with each application benefiting from the independent control of beam parameters and the elimination of expensive programmable optical elements.

A method for tuning a Bessel beam may include receiving an input light beam, generating a Bessel beam using a first axicon and a first lens, and making at least one adjustment to the Bessel beam by adjusting a Bessel beam confinement (ΔNA) of the Bessel beam by adjusting an iris disposed at a front focal plane of the first lens and/or adjusting a numerical aperture (NA) of the Bessel beam by adjusting a separation distance between two separated axicons disposed in an optical path of the Bessel beam after the first lens. This method enables real-time optimization of beam properties for different imaging conditions, allowing researchers to adapt the system to varying sample characteristics and experimental requirements without hardware changes.

The method may further include receiving a set of parameters for controlling the NA and ΔNA of the Bessel beam, and making the at least one adjustment automatically based on the set of parameters. This automated control capability enables high-throughput imaging protocols and reduces operator variability, improving reproducibility and enabling complex experimental designs that require rapid parameter changes.

A non-transitory computer readable storage device may contain instructions that, when executed by one or more processing units, may cause the one or more processing units to activate a light source, causing light to pass through a first axicon and a first lens, thereby generating a Bessel beam, and receive input, and, based on the input, adjust a Bessel beam confinement (ΔNA) of the Bessel beam by adjusting an iris disposed at a front focal plane of the first lens and/or adjust a numerical aperture of the Bessel beam by adjusting a separation distance between two separated axicons disposed in an optical path of the Bessel beam after the first lens. This software control system enables integration with existing laboratory automation systems and provides a user-friendly interface for complex beam parameter optimization.

The instructions may further configure the one or more processing units to automatically adjust the Bessel beam confinement and/or adjust the numerical aperture based on a set of predefined parameters. This automated optimization capability enables adaptive imaging protocols that can respond to changing experimental conditions, maximizing image quality while minimizing photodamage to biological samples.

The foregoing general description of the illustrative embodiments and the following detailed description thereof are merely exemplary aspects of the teachings of this disclosure and are not restrictive.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a schematic diagram of a tunable Bessel beam module.

FIG. 2 depicts a schematic diagram of the tunable Bessel beam module with housing and motorized control.

FIG. 3 shows a schematic diagram of an optical system.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

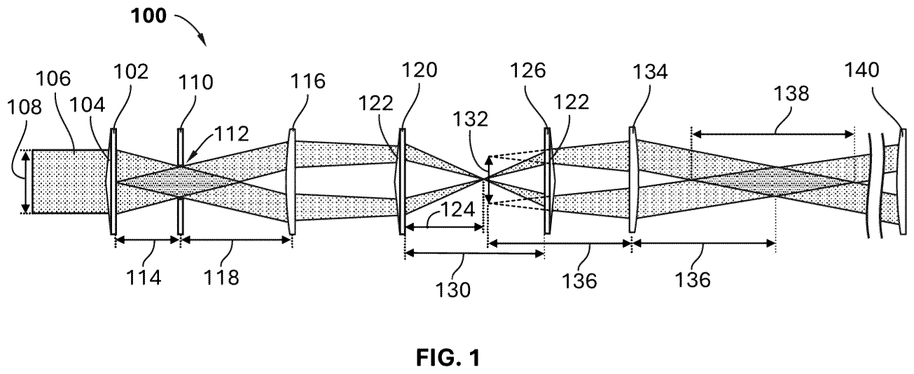

Referring to FIG. 1, a tunable Bessel beam module 100 may be configured to generate and control Bessel beam characteristics through independent adjustment of beam parameters. The tunable Bessel beam module 100 may include a first axicon 102 (A1) configured to receive light along an optical path 106. The light may have a diameter 108 (D). The first axicon 102 may have a first axicon angle 104 (a) that determines initial beam deflection properties.

The tunable Bessel beam module 100 may further include a first lens 116 disposed along the optical path 106 such that the first axicon 102 and the first lens 116 (L1) generate a Bessel beam. The first lens 116 may have a first focal length 118 (f1) that contributes to the beam formation characteristics. In some cases, the first lens 116 may be a plano-convex lens. In some embodiments, the focal length may be, e.g., 100 mm-200 mm.

An adjustable iris 110 may be disposed at a focal plane of the first lens 116. The adjustable iris 110 may control a beam diameter 108 of the light passing through the optical path 106 by adjusting a gap 112 formed by the iris. The adjustable iris 110 may be positioned at a distance 114 (d) from the first axicon 102, with gap 112 corresponding to the focal plane positioning.

As further shown in FIG. 1, the tunable Bessel beam module 100 may include two separated axicons configured to receive the Bessel beam focus from the first lens 116. The two separated axicons may comprise a second axicon 120 (A2) and a third axicon 126 (A3). The second axicon 120 may have a second axicon angle 122 (β) that contributes to beam shaping properties. The second axicon 120 and the third axicon 126 may be separated by a separation distance 130 (L) along the optical path 106.

At least one of the two separated axicons (such as third axicon 126) may be moveable along the optical path such that the separation distance 130 can be adjusted. The separation distance 130 may control a numerical aperture 132 (NA) of the generated Bessel beam. A coherence length 124 (Lc) may be maintained between the second axicon 120 and the third axicon 126 during adjustment operations.

With continued reference to FIG. 1, the tunable Bessel beam module 100 may include a second lens 134 (L2) positioned along the optical path 106 following the third axicon 126. The second lens 134 may have a second focal length 136 (f2) that contributes to final beam characteristics. In some cases, the second lens 134 may have a focal length of 100 mm-200 mm. In some implementations, the second focal length is longer than the first focal length. The configuration may result in a Bessel beam having a Bessel beam length 138 that extends along the optical path 106.

The first axicon angle 104 and the second axicon angle 122 may work in combination with the first focal length 118 and the second focal length 136 to determine the overall beam propagation characteristics. The beam diameter 108 at the input may influence the final beam properties, while the gap 112 and distance 114 positioning of the adjustable iris 110 may provide independent control of beam confinement parameters without affecting the numerical aperture 132 control provided by the separation distance 130 adjustment.

With continued reference to FIG. 1, the tunable Bessel beam module 100 may further include two separated lenses forming a 4f system disposed in the optical path 106 following the two separated axicons. The two separated lenses may include the second lens 134 and a third lens 140. The second lens 134 may be positioned after the third axicon 126 (either directly, with no intervening components such as a mirror, or indirectly, with at least one intervening component between the third axicon 126 and the second lens 134), while the third lens 140 may be positioned at a specific distance from the second lens 134 to establish the 4f optical relay configuration.

The 4f system formed by the second lens 134 and the third lens 140 may provide optical relay functionality that preserves the beam characteristics established by the two separated axicons. In the 4f configuration, the second lens 134 may collect the light emerging from the third axicon 126 and focus the light to an intermediate focal plane. The third lens 140 may then recollimate the light from the intermediate focal plane, creating a relay system that maintains the spatial and angular properties of the beam while enabling beam transport over extended distances.

The optical relay function of the 4f system may enable the tunable Bessel beam module 100 to interface with external optical components while preserving the Bessel beam characteristics. The second lens 134 and the third lens 140 may be positioned such that the distance between the lenses equals the sum of their focal lengths, creating the 4f configuration where the total optical path length is four times the focal length of each lens when the lenses have identical focal lengths.

As further shown in FIG. 1, the imaging properties of the 4f configuration may provide unit magnification relay imaging that transfers the beam profile from the output of the third axicon 126 to the output of the third lens 140 without distortion. The intermediate focal plane between the second lens 134 and the third lens 140 may serve as a Fourier transform plane where spatial filtering or beam modification can be implemented if desired for specific applications.

The 4f system may maintain the numerical aperture 132 and beam confinement characteristics established by the adjustable iris 110 and the separation distance 130 of the two separated axicons. The second lens 134 and the third lens 140 may work together to preserve the ring-shaped intensity distribution in the pupil plane that characterizes the Bessel beam, ensuring that the non-diffracting properties of the beam are maintained through the optical relay system.

The two separated lenses forming the 4f system may enable the tunable Bessel beam module 100 to provide a collimated output beam that can be efficiently coupled to downstream optical components such as scanning systems or objective lenses. The relay imaging properties of the 4f configuration may ensure that adjustments to the separation distance 130 between the two separated axicons result in predictable changes to the output beam characteristics without introducing unwanted aberrations or beam distortions.

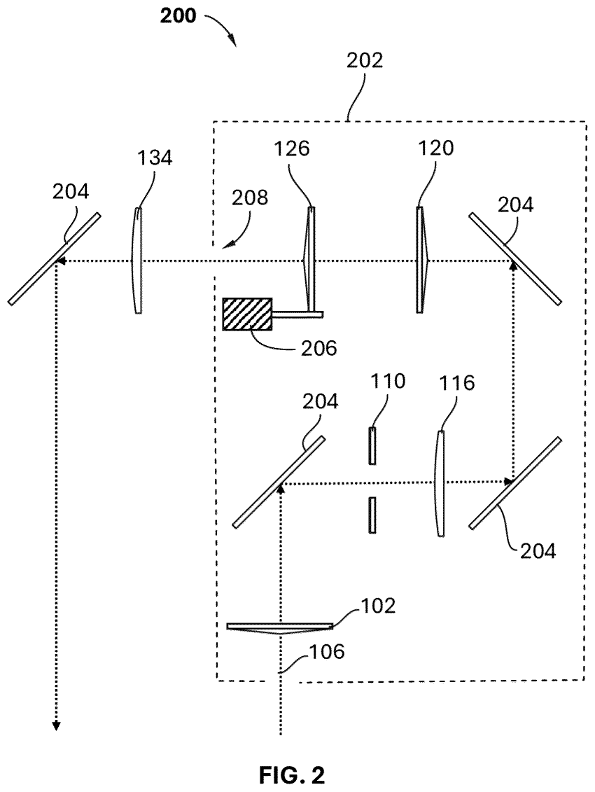

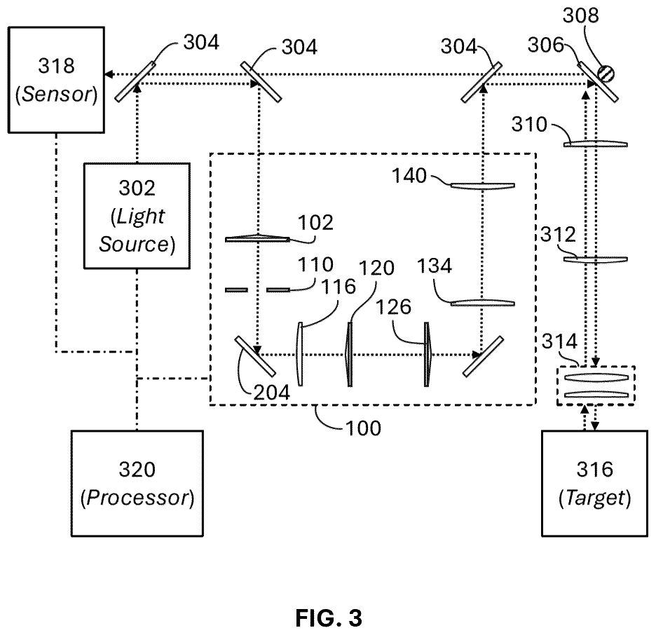

Referring to FIGS. 2 and 3, the tunable Bessel beam module 100 may further include one or more mirrors 204 disposed in the optical path 106. The one or more mirrors 204 may enable compact beam routing within the tunable Bessel beam module 100, allowing for efficient space utilization while maintaining optical performance characteristics. In some cases, the mirrors 204 may be high-reflectivity dielectric mirrors designed for specific wavelength ranges used in the optical system.

At least one of the one or more mirrors 204 may be disposed in the optical path 106 between the adjustable iris 110 and the first lens 116. This positioning may allow for beam redirection before the first lens 116 focuses the light, enabling compact folding of the optical path 106 in the initial beam formation section. The mirror 204 positioned between the adjustable iris 110 and the first lens 116 may facilitate reduction of the overall footprint of the tunable Bessel beam module 100 while preserving the beam quality and focusing characteristics.

As further shown in FIGS. 2 and 3, at least one of the one or more mirrors 204 may be disposed in the optical path 106 between the two separated axicons and the two separated lenses. The two separated lenses The mirror 204 positioned between the two separated axicons and the two separated lenses may enable beam routing after the numerical aperture 132 adjustment section, allowing for compact integration of the final beam formation components.

The mirrors 204 may facilitate folding of the optical path 106 at multiple locations within the tunable Bessel beam module 100, reducing the linear extent of the module while maintaining the optical distances between components. The compact beam routing enabled by the mirrors 204 may allow the tunable Bessel beam module 100 to be integrated as a switchable module using a linear actuator for toggling between Gaussian and Bessel beam modes. In some cases, the tunable Bessel beam module 100 may be mounted on a rail assembly allowing for easy integration into existing microscopy systems, where the mirrors 204 contribute to the modular design by enabling a compact form factor suitable for standard optical breadboards and mounting systems.

With continued reference to FIG. 2, a tunable Bessel beam module 200 may further include a housing 202 surrounding the first axicon 102, the first lens 116, the adjustable iris 110, and the two separated axicons. The housing 202 may provide mechanical stability and protection from environmental disturbances for the optical components within the tunable Bessel beam module 200. In some cases, the housing 202 may be constructed from aluminum or other materials that provide structural rigidity while minimizing thermal expansion effects that could affect optical alignment. The housing includes windows 208 to allow the optical beams to enter and exit the housing at appropriate locations.

The housing 202 may enable the tunable Bessel beam module 200 to function as a modular component that can be integrated into various optical systems. The housing 202 may protect the internal optical components from dust, vibrations, and other environmental factors that could degrade optical performance. In some cases, the housing 202 may include mounting interfaces that allow the tunable Bessel beam module 200 to be attached to standard optical breadboards or microscopy systems using conventional mounting hardware.

As further shown in FIG. 2, the tunable Bessel beam module 200 may include a motor 206 configured to control the separation distance 130 of the two separated axicons. The motor 206 may enable automated adjustment of the numerical aperture 132 of the generated Bessel beam by precisely controlling the axicon separation. In some cases, the motor 206 may be a stepper motor or servo motor that provides precise positioning control with sub-micrometer accuracy.

The motor 206 may provide dynamic control over the separation distance 130 between the second axicon 120 and the third axicon 126, enabling independent adjustment of the numerical aperture 132 while the adjustable iris 110 provides independent control of beam confinement. The motorized control may allow for real-time tuning of beam parameters without manual intervention, facilitating programmable beam configurations and automated optimization protocols. In some cases, the motor 206 may be controlled by electronic signals from a computer or control system that can execute predetermined adjustment sequences.

The motor 206 may enable close-loop alignment automation capabilities to achieve precise beam profile alignment after each adjustment. The automated control provided by the motor 206 may include feedback mechanisms that monitor beam characteristics and adjust the separation distance 130 accordingly to maintain desired beam properties. In some cases, the system may include sensors that detect beam profile parameters and provide feedback signals to the motor 206 for automatic correction of alignment variations that may occur during operation.

The separation distance 130 may be configured to lead to a Bessel beam whose length is no more than 200 μm. The relationship between the separation distance 130 and the resulting Bessel beam length may be controlled through precise positioning of the two separated axicons. In some cases, the separation distance 130 may be adjusted to produce Bessel beams with specific length characteristics tailored to particular application requirements.

The Bessel beam length may be tuned to specific ranges depending on the intended use of the optical system. In some cases, the separation distance 130 may be configured to generate Bessel beams with lengths in the range of 0-50 μm for applications requiring short propagation distances with high spatial resolution. The 0-50 μm range may be suitable for high-resolution imaging of thin samples or surface analysis applications where minimal depth penetration is desired.

In some cases, the separation distance 130 may be adjusted to produce Bessel beams with lengths in the range of 1-100 μm. The 1-100 μm range may provide a balance between spatial resolution and imaging depth, making this configuration suitable for cellular imaging applications or materials characterization where moderate depth penetration is required. The lower bound of 1 μm may ensure sufficient beam propagation for practical imaging applications while maintaining high resolution characteristics.

The separation distance 130 may also be configured to generate Bessel beams with lengths in the range of 2-150 μm. The 2-150 μm range may be appropriate for applications requiring deeper penetration into samples while maintaining reasonable spatial resolution. This configuration may be suitable for tissue imaging or thick sample analysis where extended depth of field is beneficial for capturing volumetric information without mechanical scanning.

The maximum Bessel beam length of 200 μm may be achieved through specific positioning of the separation distance 130. The upper limit of 200 μm may provide extended depth coverage for applications such as deep tissue imaging or large volume analysis while maintaining the non-diffracting properties of the Bessel beam. The 200 μm maximum length may represent a practical upper bound that balances beam propagation distance with maintaining sufficient beam quality and intensity for effective optical applications.

The precise control of Bessel beam length through adjustment of the separation distance 130 may enable optimization for different sample types and experimental conditions. The ability to tune the beam length within the range from near-zero to 200 μm may provide flexibility for adapting the optical system to various applications without requiring hardware changes beyond the motorized adjustment of the axicon separation.

Referring to FIG. 3, a system may comprise the tunable Bessel beam module 100 and one or more lenses or mirrors 304 disposed in an optical path between the tunable Bessel beam module 100 and a target 316. The system may integrate multiple optical components to enable advanced imaging capabilities with the tunable Bessel beam generated by the tunable Bessel beam module 100. The one or more lenses or mirrors 304 may provide beam steering, focusing, and relay functions that direct the Bessel beam from the tunable Bessel beam module 100 to the target 316.

The system may further include a light source 302 configured to generate the light forming the optical path 106. The light source 302 may provide coherent illumination that enters the tunable Bessel beam module 100 for conversion into the tunable Bessel beam. In some cases, the light source 302 may be a femtosecond laser system operating at wavelengths suitable for two-photon excitation applications, such as a Ti:Sapphire laser with tunable wavelength output in the near-infrared range.

With continued reference to FIG. 3, the light source 302 may be configured to generate coherent light with specific wavelength and power characteristics suitable for the optical system applications. The light source 302 may provide pulsed or continuous wave illumination depending on the imaging requirements. In some cases, the light source 302 may comprise a femtosecond pulsed laser system that generates ultrashort pulses with durations in the range of 50-200 femtoseconds, enabling two-photon excitation processes in biological samples.

The light source 302 may operate at wavelengths optimized for specific fluorophore excitation or material interaction requirements. In some cases, the light source 302 may provide tunable wavelength output in the near-infrared range, such as 700-1000 nm, which may be suitable for deep tissue penetration and reduced scattering in biological samples. The light source 302 may include wavelength selection mechanisms such as optical parametric oscillators or tunable laser systems that allow adjustment of the output wavelength to match specific experimental requirements.

The light source 302 may provide power levels suitable for the intended imaging applications while avoiding photodamage to sensitive samples. In some cases, the light source 302 may deliver average powers in the range of 1-100 mW at the sample plane, with the specific power level adjusted based on sample sensitivity and imaging speed requirements. The light source 302 may include power control mechanisms such as variable attenuators or acousto-optic modulators that enable precise adjustment of the illumination intensity.

As further shown in FIG. 3, the light source 302 may be coupled to the tunable Bessel beam module 100 through beam conditioning optics that ensure proper beam diameter and divergence characteristics. The light source 302 may provide a collimated beam with a diameter matching the input requirements of the first axicon 102. In some cases, the light source 302 may include beam expansion or compression optics to achieve the desired beam diameter 108 for optimal performance of the tunable Bessel beam module 100.

As further shown in FIG. 3, the system may include mirrors or other components positioned in the optical path between the tunable Bessel beam module 100 and the target 316. The mirrors 304 may direct the Bessel beam output from the tunable Bessel beam module 100 toward downstream optical components. The mirrors 304 may provide beam steering capabilities that enable precise alignment of the optical path while maintaining the beam characteristics established by the tunable Bessel beam module 100.

The tunable Bessel beam module 100 may direct light onto a scanning galvanometer 306 (which may include a motor 308 to direct a mirror) disposed in the optical path between the tunable Bessel beam module 100 and the target 316. The scanning galvanometer 306 may enable rapid beam positioning for high-speed imaging applications by scanning the Bessel beam across a two-dimensional plane. In some cases, the scanning galvanometer 306 may comprise resonant scanners operating at 8 kHz line rates and Y-Galvo mirrors for high-speed scanning applications, providing the rapid beam deflection capabilities for volumetric imaging.

With continued reference to FIG. 3, the system may include a first additional lens 310 and a second additional lens 312 positioned in the optical path following the scanning galvanometer 306. The first additional lens 310 and the second additional lens 312 may form part of a relay system that images the scanning galvanometer 306 onto a back focal plane of an objective lens 314. The first additional lens 310 and the second additional lens 312 may work together to control beam size and divergence characteristics as the Bessel beam approaches the objective lens 314.

The system may further include the objective lens 314 configured to focus the Bessel beam into the target 316. The objective lens 314 may have a high numerical aperture to achieve sub-cellular spatial resolution while maintaining the propagation characteristics of the Bessel beam within the target 316.

As further shown in FIG. 3, the target 316 may be positioned relative to the objective lens 314 to receive the focused Bessel beam. The target 316 may comprise biological samples, materials specimens, or other objects under investigation. When the Bessel beam illuminates the target 316, fluorescence or scattered light may be generated from the sample, providing optical signals that can be detected and analyzed, passing backwards through at least a part of the system to reach a sensor 318.

The sensor 318 may be configured to receive light from the target 316. The sensor 318 may convert optical signals generated by the target 316 into electrical signals for processing and analysis. In some cases, the sensor 318 may comprise photomultiplier tubes, photodiodes, or camera sensors suitable for detecting fluorescence signals or other optical emissions from the target 316. The sensor 318 may be positioned to collect light that travels back through the objective lens 314 after interaction with the target 316.

The sensor 318 may be configured with detection capabilities that match the wavelength characteristics of the light generated by interaction of the Bessel beam with the target 316. The sensor 318 may comprise photodetection elements with spectral sensitivity ranges that encompass the fluorescence emission wavelengths or scattered light wavelengths produced by the target 316. In some cases, the sensor 318 may include photomultiplier tubes with quantum efficiencies optimized for specific wavelength ranges, such as 400-700 nm for visible fluorescence detection.

The sensor 318 may provide signal conversion capabilities that transform optical signals into electrical signals with sufficient sensitivity and dynamic range for the imaging application. The sensor 318 may include amplification stages that boost weak optical signals to levels suitable for digital processing. In some cases, the sensor 318 may comprise avalanche photodiodes or photomultiplier tubes that provide internal gain mechanisms, enabling detection of single photon events or low-intensity fluorescence signals from the target 316.

With continued reference to FIG. 3, the sensor 318 may include temporal response characteristics that enable detection of rapid signal variations during high-speed imaging operations. The sensor 318 may have response times in the nanosecond to microsecond range, allowing capture of dynamic processes within the target 316. In some cases, the sensor 318 may comprise fast photodiodes or photomultiplier tubes with bandwidth capabilities exceeding 100 MHz, enabling detection of rapid fluorescence transients or fast scanning signals generated by the scanning galvanometer 306.

The sensor 318 may be positioned in the optical system to collect light that has interacted with the target 316 and traveled back through the objective lens 314. The sensor 318 may be coupled to the optical path through dichroic mirrors or beam splitters that separate the detection light from the excitation light path. In some cases, the sensor 318 may be positioned to collect fluorescence emission light that is spectrally separated from the excitation wavelength provided by the light source 302, enabling efficient signal detection while minimizing background interference.

The sensor 318 may include signal processing capabilities that condition the electrical signals for transmission to the processor 320. The sensor 318 may comprise analog-to-digital conversion circuits that digitize the optical signals with sufficient resolution and sampling rates for the imaging application. In some cases, the sensor 318 may include 12-bit or 16-bit analog-to-digital converters operating at sampling rates of 1-100 MHz, providing the temporal and amplitude resolution for high-quality image reconstruction.

With continued reference to FIG. 3, the system may include a processor 320 configured to control various components of the optical system. The processor 320 may coordinate operation of the light source 302, the motor 208, the scanning galvanometer 306, and/or the sensor 318 to execute imaging protocols and data acquisition sequences. The processor 320 may implement automated control algorithms that optimize beam characteristics based on sample properties or experimental requirements.

The tunable Bessel beam module 100 may enable simultaneous multiwavelength imaging with minimal chromatic aberration across different wavelengths. In some cases, the system may operate with wavelengths such as 520 nm and 635 nm simultaneously, where the tunable Bessel beam module 100 maintains consistent beam characteristics across both wavelengths. The minimal chromatic aberration properties may result from the symmetric configuration of the two separated axicons within the tunable Bessel beam module 100, which provides wavelength-independent beam shaping capabilities.

The system may be integrated with focal jumping and lateral tiling capabilities for extended field-of-view imaging across millimeter-scale volumes. The focal jumping capability may be implemented through rapid movement of the objective lens 314 or other focusing elements to capture images at different axial positions within the target 316. The lateral tiling capability may involve coordinated movement of the scanning galvanometer 306 and the target 316 to acquire overlapping image regions that can be stitched together to form large-area composite images.

The integration of the tunable Bessel beam module 100 with the scanning galvanometer 306, the objective lens 314, the sensor 318, and the processor 320 may create a complete imaging system capable of real-time monitoring of dynamic processes within the target 316. The motor 308 may enable adaptive adjustment of beam parameters during imaging sessions, allowing optimization for different sample regions or experimental conditions. The system configuration may eliminate the need for axial scanning by utilizing the extended focal region of the Bessel beam, significantly increasing volumetric imaging speed compared to conventional point-scanning microscopy systems.

The system may be configured as a microscopy system that utilizes the tunable Bessel beam for high-speed volumetric imaging applications. In a microscopy system configuration, the tunable Bessel beam may enable rapid three-dimensional imaging of biological samples with sub-cellular resolution while maintaining extended depth of field characteristics. The microscopy system may incorporate the tunable Bessel beam to achieve imaging speeds that are 10 to 100 times faster than conventional Gaussian beam microscopy systems by eliminating the need for axial scanning through the extended focal region of the Bessel beam.

The microscopy system may be particularly suitable for applications such as two-photon fluorescence microscopy, where the tunable Bessel beam provides simultaneous illumination across multiple depths within biological tissues. The system may enable real-time monitoring of dynamic processes such as blood flow, neural activity, or cellular movements within living samples. In some cases, the microscopy system may be configured for light-sheet microscopy applications where the tunable Bessel beam serves as the illumination source, providing uniform light distribution across large sample volumes while minimizing photodamage through reduced side-ring excitation.

The system may be configured as an optical tweezer system that exploits the unique propagation characteristics of the tunable Bessel beam for particle manipulation applications. In an optical tweezer system configuration, the tunable Bessel beam may provide extended trapping regions that enable manipulation of microscopic particles, cells, or nanomaterials across greater axial distances compared to conventional Gaussian beam optical tweezers. The system may allow independent control of trapping strength and axial extent through adjustment of the numerical aperture and beam confinement parameters.

The optical tweezer system may utilize the non-diffracting properties of the Bessel beam to maintain consistent trapping forces across the extended focal region. The system may enable simultaneous manipulation of multiple particles positioned at different axial locations within the Bessel beam propagation region. In some cases, the optical tweezer system may be configured for applications such as cell sorting, particle assembly, or microfluidic manipulation where the extended trapping region provides advantages over conventional point-trap systems.

The system may be configured as a medical imaging system that leverages the penetration capabilities and reduced scattering effects of the tunable Bessel beam for clinical diagnostic applications. In a medical imaging system configuration, the tunable Bessel beam may enable deep tissue imaging with improved signal-to-noise ratios compared to conventional imaging modalities. The system may be adapted for applications such as ophthalmology, where the extended depth of field characteristics of the Bessel beam may provide comprehensive imaging of retinal structures without mechanical scanning.

The medical imaging system may incorporate the tunable Bessel beam for applications such as optical coherence tomography or multiphoton imaging of tissue samples. The system may enable non-invasive imaging of biological structures with reduced photodamage through the ability to adjust beam confinement parameters to minimize unwanted excitation outside the region of interest. In some cases, the medical imaging system may be configured for intraoperative imaging applications where real-time visualization of tissue structures may guide surgical procedures.

The system may be configured as a laser machining system that utilizes the extended focal region and tunable characteristics of the Bessel beam for precision material processing applications. In a laser machining system configuration, the tunable Bessel beam may enable processing of materials with varying thicknesses without requiring mechanical adjustment of the focal position. The system may provide consistent processing characteristics across the entire beam propagation region, enabling uniform cutting, drilling, or engraving operations.

The laser machining system may exploit the ability to adjust numerical aperture and beam confinement parameters to optimize processing conditions for different materials and applications. The system may enable high-aspect-ratio drilling operations where the extended focal region of the Bessel beam maintains consistent beam diameter across significant depths within the material. In some cases, the laser machining system may be configured for applications such as semiconductor processing, where precise control of beam characteristics may enable fabrication of microstructures with specific dimensional requirements.

The system may be configured as an optical communications system that takes advantage of the propagation stability and reduced diffraction characteristics of the tunable Bessel beam for free-space optical transmission applications. In an optical communications system configuration, the tunable Bessel beam may maintain beam quality over extended transmission distances, reducing the effects of atmospheric turbulence and beam spreading that typically limit free-space optical communication systems.

The optical communications system may utilize the tunable characteristics of the Bessel beam to adapt transmission parameters based on environmental conditions or link requirements. The system may enable robust signal transmission through the ability to adjust beam confinement and numerical aperture parameters to optimize power delivery and signal quality at the receiver. In some cases, the optical communications system may be configured for applications such as satellite communications or terrestrial free-space links where the extended propagation characteristics of the Bessel beam may provide advantages over conventional Gaussian beam systems.

The versatility of the tunable Bessel beam technology may enable adaptation of the system across these diverse applications through software-controlled adjustment of beam parameters without requiring hardware modifications. The system may provide a common platform that can be reconfigured for different applications by adjusting the separation distance between the two separated axicons and the aperture of the adjustable iris. The modular design of the tunable Bessel beam module may facilitate integration into existing optical systems across various fields, providing a cost-effective solution for upgrading conventional systems with advanced beam shaping capabilities.

The adaptability of the system across multiple application domains may result from the independent control of numerical aperture and beam confinement parameters provided by the tunable Bessel beam module. The system may enable optimization for specific application requirements through real-time adjustment of beam characteristics, allowing a single system configuration to serve multiple purposes or to be adapted for changing experimental conditions. The broad applicability of the tunable Bessel beam technology may provide a unified approach to optical system design across diverse fields ranging from biological research to industrial manufacturing and telecommunications.

A method for tuning a Bessel beam may comprise receiving an input light beam that serves as the initial optical signal for beam formation. The input light beam may be provided by a coherent light source that generates collimated illumination with specific wavelength and power characteristics suitable for the intended application. The input light beam may have a predetermined beam diameter and divergence characteristics that enable effective interaction with subsequent optical components in the beam formation process.

The method may further comprise generating a Bessel beam using a first axicon and a first lens. The first axicon may receive the input light beam and convert the collimated beam into a conical wavefront through refraction at the axicon surface. The first lens may collect the light emerging from the first axicon and focus the light to form a ring-shaped intensity distribution at a focal plane. The combination of the first axicon and the first lens may create the fundamental Bessel beam structure with non-diffracting propagation characteristics.

The generation of the Bessel beam through the first axicon and first lens combination may establish the basic beam geometry that enables subsequent tuning operations. The first axicon may deflect the input light beam at angles determined by the axicon geometry and refractive index, while the first lens may provide the focusing action that creates the ring beam profile characteristic of Bessel beam formation. The interaction between the first axicon and the first lens may determine the initial spatial frequency content and propagation characteristics of the generated Bessel beam.

The method may comprise making at least one adjustment to the Bessel beam through independent control mechanisms that enable modification of beam properties without affecting other beam characteristics. The adjustment operations may be performed through manipulation of specific optical components positioned at predetermined locations within the optical system. The independent nature of the adjustment mechanisms may allow selective modification of beam parameters to optimize performance for specific applications or experimental conditions.

The method may include adjusting a Bessel beam confinement (ΔNA) of the Bessel beam by adjusting an iris disposed at a front focal plane of the first lens. The iris may control the effective aperture of the optical system by limiting the diameter of the light beam passing through the focal plane. The adjustment of the iris opening may directly affect the beam confinement parameter ΔNA, which determines the energy distribution between the central beam and the surrounding ring structure of the Bessel beam.

The adjustment of the Bessel beam confinement through the iris may enable control of side-ring excitation characteristics without affecting the numerical aperture of the beam. The iris positioned at the front focal plane of the first lens may act as a spatial filter that selectively blocks portions of the ring beam, thereby modifying the energy confinement radius and the propagation length of the resulting Bessel beam. The iris adjustment may provide a mechanism for reducing unwanted excitation outside the central beam region while maintaining the desired spatial resolution characteristics.

The method may include adjusting a numerical aperture (NA) of the Bessel beam by adjusting a separation distance between two separated axicons disposed in an optical path of the Bessel beam after the first lens. The two separated axicons may form an angle-preserving imaging system where the incident angles of individual light rays equal the output angles of corresponding light rays. The separation distance between the two separated axicons may determine the diameter of the ring beam that characterizes the Bessel beam in the pupil plane.

The adjustment of the numerical aperture through the separation distance of the two separated axicons may enable control of the spatial resolution and propagation length of the Bessel beam without introducing axial shifts in the beam position. The two separated axicons may maintain the phase characteristics of the ring beam while allowing continuous tuning of the ring diameter through mechanical positioning. The separation distance adjustment may provide precise control over the numerical aperture within a predetermined range determined by the axicon geometry and optical system configuration.

The independent control mechanisms for Bessel beam confinement and numerical aperture adjustment may enable simultaneous optimization of multiple beam parameters. The iris adjustment and the axicon separation adjustment may operate independently, allowing selective modification of beam confinement without affecting numerical aperture, or adjustment of numerical aperture without affecting beam confinement. The independent control capability may provide flexibility for adapting the beam characteristics to specific application requirements or sample properties.

The method may incorporate automated positioning control through predetermined parameter sets that define specific configurations for different scanning regions or applications. The predetermined parameter sets may specify particular combinations of iris opening diameter and axicon separation distance that optimize beam characteristics for specific experimental conditions. The automated positioning control may enable rapid switching between different beam configurations without manual adjustment of optical components.

The predetermined parameter sets may be stored in a control system that coordinates the positioning of the iris and the two separated axicons according to predefined optimization criteria. The parameter sets may include configurations optimized for different sample types, imaging depths, or resolution requirements. The automated control system may execute parameter changes in response to user commands or feedback signals from the optical system, enabling adaptive beam optimization during experimental procedures.

The method may enable real-time adjustment of beam parameters through motorized control of the iris opening and the axicon separation distance. The motorized control mechanisms may provide precise positioning with sub-micrometer accuracy, enabling fine-tuning of beam characteristics during operation. The real-time adjustment capability may allow optimization of beam parameters based on sample feedback or changing experimental conditions without interrupting data acquisition procedures.

The method may include feedback control mechanisms that monitor beam characteristics and automatically adjust the iris and axicon positions to maintain desired beam properties. The feedback control may utilize sensors that detect beam profile parameters and provide correction signals to the positioning mechanisms. The automated feedback control may compensate for thermal drift, mechanical vibrations, or other environmental factors that could affect beam stability during extended operation periods.

The tuning method may enable optimization of beam characteristics for specific applications through systematic adjustment of the beam confinement and numerical aperture parameters. The method may provide a systematic approach for matching beam properties to application requirements, such as maximizing spatial resolution for high-resolution imaging or extending propagation length for deep tissue penetration. The tuning capability may allow a single optical system to serve multiple applications through software-controlled adjustment of beam parameters without hardware modifications.

The method may further comprise receiving a set of parameters for controlling the NA and ΔNA of the Bessel beam. The set of parameters may define specific values for the numerical aperture and beam confinement characteristics that optimize the Bessel beam for particular applications or experimental conditions. The parameters may be provided through user input interfaces, stored configuration files, or automated optimization algorithms that determine optimal beam characteristics based on sample properties or imaging requirements.

The set of parameters may include numerical values that specify target numerical aperture values within the tunable range of the optical system. The numerical aperture parameters may be expressed as specific NA values, such as 0.4, 0.6, or 0.8, that correspond to particular spatial resolution characteristics suitable for different imaging applications. The parameters may also include tolerance ranges that define acceptable variations around the target values, enabling the control system to maintain beam characteristics within specified performance bounds.

The set of parameters may include beam confinement values that specify the desired ΔNA characteristics for controlling side-ring excitation and energy distribution within the Bessel beam. The beam confinement parameters may be expressed as specific ΔNA values that determine the energy confinement radius and the extent of unwanted excitation outside the central beam region. The parameters may include values optimized for different sample types, such as reduced side-ring excitation for sensitive biological samples or extended energy distribution for materials processing applications.

The parameter set may include coordinated combinations of numerical aperture and beam confinement values that have been predetermined for specific applications. The coordinated parameter combinations may represent optimized configurations for applications such as high-resolution cellular imaging, deep tissue penetration, or extended field-of-view scanning. The predetermined combinations may eliminate the need for manual optimization by providing tested configurations that achieve desired performance characteristics for common use cases.

The method may comprise making the at least one adjustment automatically based on the set of parameters. The automatic adjustment process may involve coordinated control of multiple optical components to achieve the specified beam characteristics without manual intervention. The automatic adjustment capability may enable rapid reconfiguration of the optical system for different applications or experimental conditions through software-controlled parameter changes.

The automatic adjustment process may include positioning control mechanisms that move the iris and the two separated axicons to positions corresponding to the received parameters. The positioning control may utilize motorized actuators that provide precise movement with sub-micrometer accuracy to achieve the target numerical aperture and beam confinement values. The automatic positioning may be coordinated to ensure that adjustments to one parameter do not interfere with the achievement of other parameter targets.

The automatic adjustment based on the parameter set may include feedback control loops that monitor the actual beam characteristics and compare them to the target values specified in the parameters. The feedback control may utilize beam monitoring sensors that detect numerical aperture and beam confinement characteristics in real-time during the adjustment process. The feedback information may be used to refine the positioning of optical components until the measured beam characteristics match the target parameters within specified tolerances.

The automatic adjustment process may include sequential optimization procedures that adjust individual parameters in a predetermined order to minimize interaction effects between different control mechanisms. The sequential optimization may begin with coarse adjustments to achieve approximate target values, followed by fine adjustments that achieve precise parameter matching. The sequential approach may prevent oscillations or instabilities that could occur if multiple parameters were adjusted simultaneously without coordination.

The automatic adjustment capability may enable real-time optimization of beam characteristics during experimental procedures. The real-time optimization may involve continuous monitoring of sample conditions or imaging quality metrics that trigger automatic parameter adjustments to maintain optimal performance. The real-time capability may allow the system to adapt to changing experimental conditions, such as sample drift or environmental variations, without interrupting data acquisition procedures.

The automatic adjustment based on parameter sets may include predictive algorithms that anticipate required parameter changes based on experimental protocols or scanning patterns. The predictive algorithms may preposition optical components to minimize adjustment time when transitioning between different imaging regions or experimental conditions. The predictive capability may enable seamless transitions between different beam configurations during complex experimental procedures that require multiple parameter settings.

The parameter-based automatic adjustment may include calibration procedures that establish the relationship between parameter values and the corresponding positions of optical components. The calibration procedures may create lookup tables or mathematical models that enable accurate translation of parameter specifications into precise component positioning commands. The calibration information may be updated periodically to account for mechanical wear, thermal effects, or other factors that could affect the parameter-to-position relationships.

The automatic adjustment process may include error detection and correction mechanisms that identify discrepancies between target parameters and achieved beam characteristics. The error detection may trigger corrective actions such as recalibration procedures, component repositioning, or parameter modification to achieve the desired beam properties. The error correction capability may ensure reliable operation and consistent beam quality even in the presence of mechanical variations or environmental disturbances.

The parameter-based control system may enable storage and retrieval of multiple parameter sets that correspond to different applications or user preferences. The storage capability may allow users to define custom parameter combinations for specific experimental procedures and recall these configurations for future use. The parameter storage and retrieval functionality may facilitate standardization of experimental procedures and enable consistent reproduction of beam characteristics across different experimental sessions.

The automatic adjustment based on parameter sets may include optimization algorithms that refine parameter values based on performance feedback or experimental results. The optimization algorithms may analyze imaging quality metrics or other performance indicators to suggest parameter modifications that improve system performance. The optimization capability may enable continuous improvement of beam characteristics through iterative refinement of parameter values based on accumulated experimental data.

A non-transitory computer readable storage device may contain instructions that, when executed by one or more processing units, cause the one or more processing units to perform automated control operations for tunable Bessel beam generation and adjustment. The non-transitory computer readable storage device may comprise various forms of computer-readable media, such as solid-state drives, hard disk drives, optical storage media, or flash memory devices that store executable program code. The storage device may contain software modules that coordinate the operation of optical components and provide user interfaces for system control.

The instructions stored on the non-transitory computer readable storage device may cause the one or more processing units to activate a light source, causing light to pass through a first axicon and a first lens, thereby generating a Bessel beam. The activation process may involve sending control signals to power supplies, laser controllers, or other electronic systems that operate the light source. The instructions may include initialization sequences that establish proper operating parameters for the light source, such as wavelength, power output, etc.

A non-transitory computer readable storage device may contain instructions for controlling optical system components and beam parameters. The non-transitory computer readable storage device may include solid-state memory devices, magnetic storage media, optical storage media, or other persistent storage technologies suitable for storing executable instructions. In some cases, the storage device may comprise flash memory, solid-state drives, or other non-volatile memory systems that maintain stored information when power is removed.

When executed by one or more processing units, the instructions stored on the non-transitory computer readable storage device may cause the processing units to activate a light source. The activation instructions may include power-up sequences, warm-up procedures, and stabilization routines that prepare the light source for operation. In some cases, the instructions may configure output power levels, pulse characteristics, or wavelength settings of the light source based on experimental requirements.

The instructions may cause light from the activated light source to pass through a first axicon and a first lens, thereby generating a Bessel beam. The instructions may coordinate timing and sequencing of optical component activation to ensure proper beam formation. In some cases, the instructions may include initialization procedures that verify proper alignment and operation of the optical components before beginning experimental procedures.

The instructions may configure the processing units to receive input that specifies desired beam characteristics or experimental parameters. The input may be received through user interfaces, configuration files, or automated laboratory control systems. In some cases, the input may include numerical values for beam parameters, timing sequences for parameter adjustments, or predefined parameter sets for specific experimental protocols.

Based on the received input, the instructions may cause the processing units to adjust a Bessel beam confinement (ΔNA) by controlling an iris disposed at a front focal plane of the first lens. The instructions may translate input parameters into positioning commands that adjust the iris opening diameter. In some cases, the instructions may include calibration data that relates iris positions to specific ΔNA values, enabling precise control of beam confinement characteristics.

The instructions may also cause the processing units to adjust a numerical aperture by controlling a separation distance between two separated axicons disposed in an optical path of the Bessel beam after the first lens. The instructions may convert numerical aperture specifications into positioning commands for motorized actuators that adjust the axicon separation. In some cases, the instructions may include compensation algorithms that maintain beam alignment during separation distance adjustments.

The instructions may enable integration with laboratory automation systems through standardized communication protocols and control interfaces. The instructions may support synchronization with external equipment, data acquisition systems, or sample positioning stages. In some cases, the instructions may include error handling routines that detect and respond to hardware faults or communication failures during system operation.

The instructions may implement feedback control loops that monitor beam characteristics and adjust optical components to maintain desired parameters. The feedback control may utilize sensor data to verify that beam adjustments achieve target specifications. In some cases, the instructions may include adaptive algorithms that optimize beam parameters based on real-time performance measurements or experimental feedback.

The instructions may further configure the one or more processing units to automatically adjust the Bessel beam confinement and/or adjust the numerical aperture based on a set of predefined parameters. The predefined parameters may comprise optimized configurations that have been determined through experimental characterization or theoretical modeling for specific applications or sample types. The automatic adjustment capability may enable the system to adapt beam characteristics without user intervention, providing consistent performance across different experimental conditions.

The set of predefined parameters may include parameter combinations that optimize beam characteristics for high-speed imaging applications operating at kilohertz frame rates. The predefined parameters may specify numerical aperture and beam confinement values that enable line-scan applications for tracking ultrafast hemodynamics in biological samples. In some cases, the predefined parameters may include configurations optimized for imaging blood flow dynamics at temporal resolutions exceeding 1000 Hz, enabling capture of rapid physiological processes that occur on millisecond timescales.

The automatic adjustment based on predefined parameters may include adaptive optimization capabilities that modify beam characteristics in response to changing experimental conditions. The adaptive optimization may monitor system performance metrics such as signal-to-noise ratio, image contrast, or temporal resolution to determine when parameter adjustments may improve performance. The adaptive capabilities may enable the system to maintain optimal beam characteristics despite variations in sample properties, environmental conditions, or system drift over extended operation periods.

The predefined parameters may include temporal sequences that coordinate beam parameter changes with experimental protocols or scanning patterns. The temporal sequences may specify when to adjust numerical aperture or beam confinement during multi-phase experiments or when transitioning between different imaging regions. In some cases, the predefined parameters may include timing information that synchronizes beam adjustments with sample positioning, stimulus presentation, or data acquisition triggers to ensure optimal beam characteristics for each phase of an experimental procedure.

The automatic adjustment capability may incorporate predictive algorithms that anticipate required parameter changes based on experimental protocols or sample characteristics. The predictive algorithms may analyze experimental metadata, sample properties, or historical performance data to determine optimal parameter settings before beginning data acquisition. The predictive capability may reduce adjustment time and minimize interruptions to experimental procedures by prepositioning optical components according to anticipated requirements.

The instructions may configure the processing units to implement closed-loop control systems that continuously monitor beam characteristics and adjust parameters to maintain target specifications. The closed-loop control may utilize feedback from beam monitoring sensors, image quality metrics, or experimental performance indicators to trigger automatic parameter adjustments. The continuous monitoring capability may enable real-time optimization of beam characteristics during dynamic experimental conditions where sample properties or imaging requirements change over time.

The predefined parameters may include error correction protocols that specify automatic responses to detected deviations from target beam characteristics. The error correction protocols may define threshold values for acceptable parameter variations and specify corrective actions when these thresholds are exceeded. In some cases, the error correction may include automatic recalibration procedures, component repositioning sequences, or parameter modification algorithms that restore optimal beam characteristics when system performance degrades.

The automatic adjustment based on predefined parameters may include machine learning algorithms that refine parameter selections based on accumulated experimental data and performance feedback. The machine learning algorithms may analyze correlations between parameter settings and experimental outcomes to identify optimal configurations for specific applications or sample types. The learning capability may enable continuous improvement of system performance through iterative refinement of predefined parameter sets based on experimental results.

The instructions may configure the processing units to coordinate automatic parameter adjustments with external laboratory equipment or data acquisition systems. The coordination capability may enable synchronization of beam parameter changes with sample positioning, environmental control systems, or measurement instrumentation. In some cases, the coordination may include communication protocols that allow external systems to request specific beam configurations or provide feedback that triggers automatic parameter adjustments.

The predefined parameters may include safety protocols that limit automatic adjustments to prevent damage to samples or optical components. The safety protocols may define maximum adjustment rates, power limits, or parameter ranges that ensure safe operation during automatic control sequences. The safety limitations may prevent excessive beam intensities, rapid parameter changes, or configurations that could cause photodamage to sensitive biological samples during automated operation.

The automatic adjustment capability may include diagnostic routines that verify proper system operation and parameter achievement during automated control sequences. The diagnostic routines may compare achieved beam characteristics to target specifications and generate alerts or corrective actions when discrepancies are detected. The diagnostic capability may ensure reliable automated operation by detecting and responding to hardware malfunctions, alignment errors, or parameter drift that could affect experimental results.

The instructions may enable storage and management of multiple sets of predefined parameters corresponding to different users, applications, or experimental protocols. The parameter management capability may allow users to define custom parameter sets, share configurations between users, or maintain libraries of optimized settings for specific applications. The storage capability may facilitate standardization of experimental procedures and enable consistent reproduction of beam characteristics across different experimental sessions or research groups.

The automatic adjustment based on predefined parameters may include optimization algorithms that balance multiple performance criteria such as spatial resolution, imaging speed, and signal quality. The optimization algorithms may evaluate trade-offs between different beam characteristics and select parameter combinations that achieve the best overall performance for specific applications. The multi-criteria optimization may enable automatic selection of beam parameters that maximize experimental effectiveness while maintaining acceptable performance in all relevant metrics.

### Example 1—Assembly and Incorporation of a tBessel Module in TPFM

The tBessel module comprises three axicons, three lenses, and one iris to achieve independent control over the numerical aperture (NA) and the energy confinement of the generated Bessel beam. The first axicon (AX252B, Thorlabs) splits incoming collimated illumination beam into a Bessel beam. An iris (SM2D25D, Thorlabs) is positioned at the minimum beam waist of the generated Bessel beam, corresponding to the sample conjugated plane, to tune the energy confinement of the Bessel beam. A plano-convex lens (AC254-125-B, Thorlabs) follows the iris with its front focal plane aligns with the iris. Next, a paired of axicons with identical angles (AX255B, Thorlabs) are positioned to control the NA of the Bessel beam. Last, a 4f lens pair (AC254-125-B and AC254-150-B, Thorlabs) relays the virtual ring focus onto a galvo scanner conjugated to the back focal plane of the objective. The entire tBessel module can be integrated into any commercial TPFM with two mirrors mounted on a rail assembly, allowing for easy toggle between Gaussian and Bessel beam. In our experiments, imaging was performed with a custom-built two-photon microscope, Modular In vivo Multiphoton Microscopy System (MIMMS), designed by Janelia Research Campus of Howard Hughes Medical Institute. In its conventional operation mode (‘Gaussian mode’), after beam expansion, the excitation laser went through Pockels cell and beam expander. tBessel module was installed as a switchable module using a linear actuator between the resonant scanner and the mirror before the resonant scanner in the conventional laser path. In the common laser path part, laser was focused onto a resonant scanner that scanned the focus along the x axis at an 8 kHz line rate. Then the excitation light was scanned by a Y-Galvo mirror. Finally, the Y-Galvo was optically conjugated by the pupil relay to the back focal plane of the imaging objective.

### Example 2—Tunable Bessel Beam Two-Photon Fluorescence Microscopy

In contrast to conventional TPFM that scans an axially localized Gaussian beam across a 3D volume, Bessel-TPFM images the same volume by scanning an axially extended Bessel beam across a 2D plane. When the length of the Bessel beam matches the depth of the 3D volume, the resulted Bessel-TPFM image is equivalent to the 2D projection of the 3D volume from the conventional Gaussian-TPFM, but at an acquisition rate 10- to 100-fold faster.

When it comes to hemodynamics imaging, three parameters of the Bessel beam matter: beam length, spatial resolution, and energy confinement.

First, while longer Bessel beam can cover larger volumes with the same frame rate, it also leads to increased structural overlaps between blood vessels from different depths, and, therefore, information degeneration. To identify the desired Bessel beam length, the distributions of axial inter-vessel distance (AIV) were quantified at various depths inside mice cerebral cortex from the 3D Gaussian-TPFM images, the AIV distributions were fit with gamma functions, and peaks corresponding to the mode of the AIV were located. Bessel beams with length much shorter than the mode of the AIV lead to information-sparse images, while beams with length much longer than the mode of the AIV result in images with significant structural overlaps. Importantly the mode of the AIV varies at different depths of mice brains, calling for tunability of the Bessel beam length.

Second, whereas high resolution Bessel beam is desired to resolve small features, it also slows down acquisition speed. To optimize the spatial resolution, the distributions of blood vessel inner diameter were characterized and, again, it was found that the averaged blood vessel inner diameter varies at different depths of mice brains, calling for adjustability of the Bessel beam spatial resolution.

Last, Bessel beams with high spatial resolution and extensive length also have substantial sidering fluorescence excitations, potentially lead to imaging artifacts. Therefore, controllability in the energy confinement of Bessel beam is highly desired to strike a balance between resolution, speed, and accuracy.

To address these needs, the compact tunable Bessel (tBessel) module of Example 1 can be readily integrated into conventional TPFM. For broad adoptability and high light efficiency, tBessel module only uses off-the-shelf optics without involving programmable or diffractive elements. First, a standard axicon-lens pair was used to convert a collimated light source into a focused ring beam-Fourier transform of a Bessel beam—at a pupil-conjugate plane. Second, to enable tunability, the size and thickness of the ring beam, corresponding to numerical aperture (NA) and NA broadening (ΔNA), needs to be adjustable. Various strategies that employ different combinations of lenses and axicons have been attempted, however, they all face a key challenge: changing the NA of the beam leads to an axial shift of the Bessel beam, which results in a unwanted translation of the imaging volume. The disclosed tunable Bessel beam module overcomes this challenge by exploiting the fact that a pair of identical axicons (A2 and A3) can be used to continuously tune the diameter of the focused ring beam (i.e. NA of the Bessel beam)—by varying their separation—while introducing minimum phase variations to the ring beam, therefore, leading to negligible axial shift of the Bessel beam. Third, an iris conjugated to the objective focal plane was set up to enable tuning of the Bessel beam's energy confinement (i.e., its side ring excitation) without axial shift. Importantly, the tunings of the NA and ΔNA of the Bessel beam NA does not affect each other, allowing for independent control of the spatial resolution and energy confinement

Next, the performance of the tBessel module was experimentally characterized and the results compared with theoretical calculations and numerical simulations. First, by varying the distance between the axicon pairs, the resolution of the Bessel beam can be adjusted as evidenced by the beam profile images, which match with the simulations. Quantitatively, the NA of the Bessel beam depends linearly on the distance between the axicon pairs with a tunability range from 0 to 1.0. In addition, changing the distance between the axicon pairs allow for adjustment of the Bessel beam length. Second, by changing the size of the iris opening, the ΔNA of the Bessel beam can be changed evidenced by the pupil profile images, which show consistency with the simulations. Quantitatively, the ΔNA of the Bessel is inversely proportional to the iris opening. Besides, the energy confinement radius, defined as the radius where half of the total power is contained, and the length of the Bessel beam depends linearly on the iris opening. Noticeably, good alignment between experiments and theory/simulations were observed in Bessel beams with a broad range of spatial resolution, energy confinement, and propagation length.

Last, an important advantage of the disclosed tunable Bessel beam module is its capability for simultaneous multicolor imaging, in contrast to spatial light modulator (SLM) based approaches that need to alternate between different SLM patterns for different wavelengths. As an example, simultaneous generation of a 520 nm and 635 nm Bessel beam were demonstrated, where no lateral chromatic shift was observed. Moreover, after scaling each beam profile by its corresponding wavelength, the two Bessel beams coincide with each other. Furthermore, the pupil images of the two colors align with each other, indicating the two colors have the same NA. Indeed, when the distance changed between the axicon pairs, consistent NA was observed between the two colors across a broad range of NAs. Together, the results suggest that the tunable Bessel beam module introduces minimum chromatic aberrations largely thanks to the symmetric configuration of the axicon pair (e.g., A2 and A3).

### Example 3—Cortical-Wide Hemodynamics Mapping with Sub-Capillary Resolution

The optical performance of tBessel-TPFM was assessed for hemodynamics imaging in live mice brains, whose vasculatures are labeled with dextran-conjugated Rhodamine B. Representative images over 400×400×120 μm³ volume from the same mouse cortical region taken with Gaussian foci and Bessel beams with different NAs (NA=0.4,0.6, and 0.8) highlight two key points. First, a comparison between the 2D projected 3D Gaussian image stacks composed of 120 frames and the single 2D image taken by the Bessel beam with comparable length (NA=0.4) confirms their equivalence in structural imaging, but drastically improved volumetric throughput (120-fold) via the Bessel beam. Second, tBessel-TPFM allows for adjustment of the spatial resolution and projected imaging depth without axial translation of the imaging volume. A comparison between vasculature images and fluorescent beads captured with Bessel beams different NAs shows an intrinsic tradeoff of Bessel beam: higher NA leads to extended spatial frequency components in the corresponding Fourier transforms, but also results in reduced projected imaging depths. Next, tBessel-TPFM was applied to quantitively measure the blood flow speed. The same 400×400×120 μm³ volume was imaged at 58 Hz and sub-capillary resolution of the tBessel-TPFM allows tracking of blood vessel movements within capillaries. Blood vessel segments were then manually traced in the time-lapse image set and their 3D lengths measured by locating the segments in the 3D Gaussian structural data taken before the time-lapse images. To measure blood flow speed, pixels along the segments in the time-lapse image series were plotted against time to obtain the kymograph. Red blood cells, which were not labeled with fluorescent dyes, showed up as dark streaks in the kymograph. The medians slopes of these dark streaks were calculated as the blood flow speed. This pipeline was applied to 42 blood vessel segments with diameters from a few to twenty microns, and found a positive correlation between the vessel diameter and blood flow speed, consistent with previous literature.

We also consider a theoretical calculation of maximum measurable blood flow speed. Consider a blood vessel oriented at an angle θ relative to the horizontal plane. Let B denote the length of the Bessel-illuminated region, and c represent the characteristic size of the blood cells under observation. If t is the time interval between the entry and exit of a blood cell through the Bessel-illuminated area, then the maximum measurable blood flow speed is:

$${V}_{max} = \frac{l}{t} = \frac{B + c}{sin θ} \cdot \frac{1}{t}$$

Conventionally, one would need at least 4 frames to track the blood cell; thus this maximum is further decreased by 4 times.

To capture distributed hemodynamics over extended 3D cortical volumes, tBessel-TPFM was integrated with lateral tiling and focal jump, realized by rapid piezoelectric actuators movement, to enlarge the imaging field-of-view (FOV) and depth, respectively. As a demonstration, a 0.4 NA and 150 μm long Bessel beam was generated for time-lapse imaging of blood flow across a millimeter cortical volume. Each single scan covers a volume of 700×700×150 μm³, taking 33 ms per scan. 3 step axial focal jumps and 4×4 lateral tiles with 45 μm overlap were performed resulted in a total of 48 axially and laterally stitched images, covering a total volume of 2,500×2,500×450 μm³. Images for each Bessel focus capturing vasculatures within 0-150, 150-300, 300-450 μm below the dura mater, respectively, were color-coded with cyan, magenta, and yellow. A combined image of the 2,500×2,500×450 μm³ volume highlights several features: First, large diameter pial vessels were prominent in the most superficial image (cyan color), and become sparse deeper within the brain. Second, tBessel offers sub-capillary resolution, evidenced by clearly resolved capillaries that dominate the vasculatures in deeper cortical layers. Third, the prolonged axial projection capability of tBessel beam together with the integrated focal jump can reveal penetrating arterioles or venules that run down almost vertically. Last, the high spatial resolution and rapid volumetric imaging capabilities of tBessel enables reliable monitoring of the vasodilation and vasoconstriction temporal variations in vessel size.

### Example 4—High Throughput Imagining of Neurovascular Coupling with Minimum Motion Artifacts in Awake Mice

Neuronal activation is often accompanied by quick increase in regional blood flow to ensure nutrients supply and metabolic waste removal via neurovascular coupling (NVC). Disruptions of NVC can lead to a range of neurological and psychiatric diseases. This example involved simultaneously monitoring the neuronal activity through the genetically encoded calcium indicator (GCaMP) and vasculature hemodynamics within the primary visual cortex (V1) of awake mice while applying visual stimuli. One critical challenge faced by conventional Gaussian-TPFM to study NVC in awake mice is motion artifacts. Whereas lateral motion artifacts can be easily corrected computationally, axial motion, typically around several microns in amplitude, can shift structures out of the Gaussian focus. As an example, 2D time-lapse imaging was performed 60 μm below pia over a 400×400 μm2 FOV at 30 Hz.

Kymograph of a representative image column shows sporadic but high amplitude fluctuations, manifestations of axial motion artifacts. To further visualize axial motion artifacts, images taken at different time points across a 20 s period were color-coded and combined. Significant structural shifts in and out of the Gaussian focal plane were observed. In contrast, axial motion leads to minimum artifacts in tBessel-TPFM thanks to the extended focus of the Bessel beam. The same FOV was imaged using a 0.4 NA Bessel beam at 30 Hz. Kymograph analysis of the same image column shows little amplitude fluctuations. In addition, color-coded time-lapse image does not exhibit noticeable structural shift.

Next, NVC across cortical layers in V1 were investigated by integrating tBessel-TPFM with the aforementioned focal jumping method. First, 3D Gaussian imaging was performed over the targeted cortical volume of 260×260×400 μm³ at 2.5 Hz, and different projection depths were attempted to identify the desired Bessel beam length: 80 μm depth with five focal jumps was chosen to balance imaging speed with structural overlaps. Second, the tBessel module was adjusted to match the desired length, and the beam length was confirmed by comparing Bessel images with projected Gaussian images at each of the five focal jumps.

With the selected Bessel beam, we simultaneously monitored neuronal calcium activities and vasculature hemodynamics at 3 volumes per second over the 260×260×400 μm³ cortical regions while applying moving gratings stimuli. As expected, trial-averaged calcium traces from multiple neurons showed strong direction selectivity in response to moving gratings. In order to investigate vasculature responses, three representative blood vessels per imaging plane were selected with a total of 15 vessels, covering a broad diameter range with arterioles and venules in the most superficial image and capillaries in the deeper images. Each selected blood vessels was then line-cut, and the time-lapse imaging stacks sorted by the grating moving directions to obtain a space-time plot. Each of the space-time plots were segmented to obtain the time blood vessels diameter changes over time, which revealed clear dilation responses to visual stimulations. Arterioles show rapid and sustained dilation in response to contralateral visual stimulation, whereas neighboring venules exhibit little change in lumen diameter. Furthermore, the peaks of vasodilation always lag the peaks of neuronal activities, suggesting activity evoked vascular events via NVC. Next, the same analysis was applied to all 15 blood vessels and it was observed that the largest vasodilation induced by visual stimulation coming from blood vessels in the most superficial layer. Furthermore, cross correlation analysis was conducted and it was also found that the highest correlation coefficient between neuronal activities and blood vessels diameter coming from blood vessels in the superficial layer. However, it is worth noting that the correlation coefficient between neuronal activities and vasodilation of penetrating arterioles remain even in deep layer.

### Example 5—Segmentation-Free Mapping of Vasodilation in Responses to Visual Stimuli

Although the manual line-cut and segmentation pipeline described above worked well, it is cumbersome and prone to error at low signal-to-noise (SNR), preventing large-scale high throughput spatial mapping of vasodilation and vasoconstriction regulated by NVC. Importantly, unlike Gaussian-TPFM whose fluorescence intensity is insensitive to vessels diameter, Bessel TPFM provides a positive correlation between the fluorescence intensity and vessel diameter. This correlation was demonstrated by imaging the spontaneous hemodynamics within a cortical volume of 1,400×1,400×150 μm³ at 15 Hz in head-fixed awake mice. Zoomed-in views of the vasculatures at two different time points reveal that blood vessel undergoing vasoconstriction exhibit a decrease in fluorescence intensity whereas vessels with unchanged diameters show no variation in fluorescence intensity, suggesting that the fluorescence change is a result of vessel diameter change. This unique property of Bessel-TPFM can be intuitively understood as follows: in contrast to Gaussian beam with tight axial confinement, Bessel beam captures the accumulated fluorescence intensity from the vessel's entire axial cross-section. Therefore, vasoconstriction results in accumulation of fluorescence from larger axial cross-section and leads to proportionally higher fluorescence. To test this hypothesis experimentally, vessels were first selected from three regions of interest (ROIs) and their time varying diameters and fluorescence intensity were compared. A strong positive correlation was observed between their diameters and fluorescence intensity with R² ranging from 0.72 to 0.90. Furthermore, this unique property of Bessel-TPFM was confirmed by analyzing fluorescence intensities from blood vessels with diameters ranging from 5 to 75 μm (a total of 20 blood vessels) and obtained a strong positive correlation (R²=0.81).

The unique correlation between vessel diameter and fluorescence intensity enables pixelwise mapping of vasoconstriction and vasodilation in response to visual stimulations without the tedious manual line-cut and segmentation. To demonstrate the applicability of this capability, gratings moving different directions were presented to awake mice, imaged with our tBessel-TPFM, and analyzed the time courses of the fluorescence intensity change from the same three ROIs. By comparing the averaged responses between dark versus the presence of moving gratings, we observed statistically significant increase of fluorescence intensity upon visual stimulations. Next, pixelwise vasculature light responsiveness maps and orientation selectivity maps where color-coded pixels represent the maximum response orientations of the blood vessels were generated. These maps highlighted several key features. First, arterial blood vessels were significantly more responsive to neural stimulation than venous, which is consistent with previous findings. Second, unexpected orientation selectivity was found in the pia artery and penetrating arterioles. While such orientation selectivity was observed in cats and primates, it was reported absent in rodents. This discrepancy may be attributed to the difference in scales of brain areas under observation, which warrants further mechanistic investigations. Third, it was discovered that venules tend to exhibit preferred orientations perpendicular to nearby arterioles during visual stimulation. This phenomenon may be explained by the negative correlation in diameter changes between arterioles and venules, which was confirmed and found consistent with a previous report.

Furthermore, by integrating with focal jump, both light responsiveness and orientation selectivity maps from different planes across cortical layers were generated. Larger differential responses toward grating directions were generated from small-diameter capillaries, in comparison to large-diameter arterioles, in the shallower cortical layers, consistent with previous reports. Interestingly, a trend of reduced light responsiveness and orientation selectivity along with weaker correlation between neuronal activity and hemodynamics in deeper cortical layers was found. This may be attributed to the increasing branch orders of capillaries, which is associated with reduced contractility or decreased frequency of NVC responses. The capability to create pixelwise maps of vascular responses, allowing the study of spatially distributed NVC, is made possible only by the unique property of Bessel TPFM whose fluorescence intensity positively correlates with blood vessel diameter.

### Example 6—Tracking Hemodynamics in Ischemic Stroke Mice at Kilohertz Rate

While tBessel-TPFM offers orders of magnitude speedup over Gaussian-TPFM in volumetric hemodynamics imaging, it is still limited to ~100 Hz frame rate due to the need for 2D planescan. In order to measure ultrafast hemodynamics that is particularly relevant in large-diameter veins and arterioles, 1D line-scan at kilohertz or higher have been explored. In the simplest implementation, a Gaussian beam is scanned back and forth along the targeted blood vessel via synchronized galvo-galvo movements, and a kymograph was obtained to extract the flow velocity. However, there is an intrinsic limit with 1D line-scan using Gaussian beams: only blood vessels traveling nearly parallel to the focal plane can have segments long enough within the depth of focus of the objective for speed measurement. For example, at least 15 μm long segment is needed to measure blood flow speed up to 15 mm/s when imaging at 1 kHz frame per second (fps). A Gaussian beam with 2 μm depth of focus can only capture vessels oriented within 7.6° from the focal plane.

Next, the orientation distributions of blood vessels within mouse cortex was analyzed, and it was found that the orientation of blood vessels has a relatively uniform distribution despite some fluctuations. This means that 1D line-scan with Gaussian beam is incapable of tracking majority (~90%) of the blood vessels within the cortical areas, such as those penetrating arterioles that run almost vertically. On the contrary, Bessel beams with extended axial propagation can cover blood vessels with a wide range of orientations. The maximum measurable flow speed of blood vessels was simulated at different orientations using Bessel beams with different lengths when performing 1D line-scan at 1 kHz.

### Theoretical Analysis of Tunable Bessel Module

A pair of axicons with identical apex angle form an angle-preserving imaging system, where the incident angles of individual light rays equal to the output angles of corresponding light rays. This unique angle-preserving property of axicon pair is central to the success of the disclosed tunable Bessel module.

The input beam diameter as is defined as D, axicon 1 (A1) having angle of a, the iris opening diameter as l, the lens 1 (L1) have a focal length of f₁, the pair of axicon A2-A3 having equal angle of β, and are separated by L, the lens 2 (L2) have a focal length of f₂. All the axicons have the same refraction index n. Geometrical optics analysis give the following relationships:

### Control of ΔNA and Bessel Beam Length (B) Via Iris:

$$Δ NA = 1.22 \frac{λ {f}_{1}}{l} \cdot 2 = 2.44 \frac{λ {f}_{1}}{l}$$

$$B = \frac{2 l}{NA} \cdot \frac{{f}_{2}^{2}}{{f}_{1}}$$

### Control of NA Via Axicon Pair (A2-A3) Separation L

$$NA = 2 ( L - {L}_{c} ) \cdot tan ( β ( n - 1 ) )$$

where

$${L}_{c} = {f}_{1} \cdot \frac{tan ( α ( n - 1 ) )}{tan ( β ( n - 1 ) )} ≃ {f}_{1} \cdot \frac{α}{β}$$

The range of L needed is

$${L}_{c} \leq L \leq \frac{{NA}_{max}}{2 \cdot tan ( β ( n - 1 ) )} + {L}_{c}$$

While the axicon pair A2-A3 can be, in principle, placed anywhere after L1, it is preferable to place A2 before the focal plane of L1, and place A3 after the focal plane of L1.

The distance between the iris and A1 is:

$$d ≃ \frac{D}{4 ( n - 1 ) α}$$

There is an implicit restriction due to the size of the optical component. Assume each component is circular in shape, with diameter a. Then, one has the following constraint

$$2 {f}_{1} tan α ( n - 1 ) + l \leq a$$

Notice that the left side is equivalent to the ring from A1 directly to L1, and the largest 1 that can take is D/2, thus the above relation translate to:

$$2 ( {f}_{1} + d ) tan α ( n - 1 ) \leq a$$

This gives an upper bound of the input beam diameter: D≤2a−4f₁α(n−1).

A 60 μm long Bessel beam can track flow speed up to 15 mm/s even from blood vessels that orient 800 relatively to the focal plane. On the other hand, to validate that 1D line-scan with Bessel beam yields the correct speed measurement results, a side-by-side comparison was performed between 1D line-scan with Bessel beam and Gaussian beam measuring the flow speed of the same blood vessel with a horizontal spanning of ~20 μm. No statistically significant difference between the two beams were observed, confirming the effectiveness of using the disclosed tBesselTPFM with 1D line-scan to quantify ultrafast hemodynamics.

Last, tBessel-TPFM was applied with 1D line-scan to an established ischemic stroke model in mice for the investigation of changes in hemodynamics before and after stroke induction via photothrombosis. Rose Bengal was injected intraperitoneally into the blood stream and targeted brain areas were illuminated with a 532 nm laser, which photoactivates Rose Bengal and induces endothelial damage and thrombosis. LSI confirmed sharp drop of blood flow in the targeted brain area (~100 μm in diameter) with well characterized ischemic brain damage. Using 1D line-scan tBessel-TPFM, the flow speeds of 17 blood vessel segments across a 1,400×1,400×140 μm³ cortical volume were mapped before and after stroke induction. In order to obtain the correct kymograph, 3D Gaussian image stacks were taken before and after each session to extract precise vessel lengths. Median flow speeds over a 5 s period of imaging were calculated to represent the flow speeds of individual blood vessels. Before stroke induction, rapid blood flow with speed up to 23.0 mm/s of arterioles and 11.7 mm/s of veins were found, confirming the capability of 1D tBessel-TPFM line-scan to track a wide range of flow speeds over large brain volumes. A linear dependence between the blood vessels' diameter and flow speeds were observed. Interestingly, for blood vessels with the same diameter, blood flow three times faster within arterioles than within veins. After stroke induction, sharp drops—as large as 100-fold of flow speed were observed from nearly all blood vessels. This data confirms that the combination of tBessel-TPFM with 1D line-scan offers the capability to spatially map stroke induced blood flow changes across blood vessels with a wide range of flow speeds.

A number of implementations have been described. Nevertheless, it will be understood that various modifications may be made without departing from the spirit and scope of the disclosure. Accordingly, other implementations are within the scope of the following claims.

1. A tunable Bessel beam module, comprising:
a first axicon configured to receive light along an optical path;
a first lens disposed along the optical path such that the first axicon and the first lens generate a Bessel beam;
an adjustable iris disposed at a focal plane of the first lens; and
two separated axicons configured to receive the Bessel beam focus from the first lens, the two separated axicons separated by a separation distance along the optical path, where at least one of the two separated axicons is moveable such that the separation distance can be adjusted.

2. The tunable Bessel beam module of claim 1, further comprising two separated lenses forming a 4f system disposed in the optical path following the two separated axicons.

3. The tunable Bessel beam module of claim 2, further comprising one or more mirrors disposed in the optical path.

4. The tunable Bessel beam module of claim 3, wherein at least one of the one or more mirrors is disposed in the optical path between the adjustable iris and the first lens.

5. The tunable Bessel beam module of claim 3, wherein at least one of the one or more mirrors is disposed in the optical path between the two separated axicons and the two separated lenses.

6. The tunable Bessel beam module of claim 1, further comprising a housing surrounding the first axicon, the first lens, the adjustable iris, and the two separated axicons.

7. The tunable Bessel beam module of claim 1, further comprising a motor configured to control the separation distance of the two separated axicons.

8. The tunable Bessel beam module of claim 1, wherein the separation distance is configured to lead to Bessel beam whose length is no more than 200 μm.

9. A system, comprising:
a tunable Bessel beam module of claim 1; and
one or more lenses or mirrors disposed in an optical path between the tunable Bessel beam module and a target.

10. The system of claim 9, further comprising a light source configured to generate the light forming the optical path.

11. The system of claim 9, further comprising a sensor configured to receive light from the target.

12. The system of claim 9, wherein at least one of the one or more lenses or mirrors forms a scanning galvanometer.

13. The system of claim 9, wherein at least one of the one or more lenses or mirrors is an objective lens.

14. The system of claim 9, wherein the system defines a microscopy system, an optical tweezer system, a medical imaging system, a laser machining system, or an optical communications system.

15. A method for tuning a Bessel beam, comprising:
receiving an input light beam;
generating a Bessel beam using a first axicon and a first lens; and
making at least one adjustment to the Bessel beam by:
adjusting a Bessel beam confinement (ΔNA) of the Bessel beam by adjusting an iris disposed at a front focal plane of the first lens; and/or
adjusting a numerical aperture (NA) of the Bessel beam by adjusting a separation distance between two separated axicons disposed in an optical path of the Bessel beam after the first lens.

16. The method of claim 15, further comprising receiving a set of parameters for controlling the NA and ΔNA of the Bessel beam, and making the at least one adjustment automatically based on the set of parameters.

17. A non-transitory computer readable storage device containing instructions that, when executed by one or more processing units, causes the one or more processing units to:
activate a light source, causing light to pass through a first axicon and a first lens, thereby generating a Bessel beam; and
receive input, and, based on the input:
adjust a Bessel beam confinement (ΔNA) of the Bessel beam by adjusting an iris disposed at a front focal plane of the first lens; and/or
adjust a numerical aperture of the Bessel beam by adjusting a separation distance between two separated axicons disposed in an optical path of the Bessel beam after the first lens.

18. The non-transitory computer readable storage device of claim 17, wherein the instructions further configure the one or more processing units to automatically adjust the Bessel beam confinement and/or adjust the numerical aperture based on a set of predefined parameters.
